(19) United States
(12) Patent Application Publication
(10) Pub. No.: US 2024/0428502 A1
(43) Pub. Date: Dec. 26, 2024

(54) Displays with Varying Update Frequencies for Different Content Types

(71) Applicant: Apple Inc., Cupertino, CA (US)

(72) Inventors: Fu-Chung Huang, Cupertino, CA (US); ByoungSuk Kim, Palo Alto, CA (US); Felipe Bacim De Araujo E Silva, San Jose, CA (US); Hao Chen, Santa Clara, CA (US); Igor Kozintsev, San Jose, CA (US); Pavel V Dudrenov, San Francisco, CA (US); Ping-Yen Chou, Santa Clara, CA (US); Seung Wook Kim, San Jose, CA (US); Sheng Zhang, Saratoga, CA (US); Victor H Yin, Cupertino, CA (US); Wei H Yao, Saratoga, CA (US); Wei Xiong, Mountain View, CA (US); Yang Li, San Jose, CA (US); Yi Huang, San Jose, CA (US); Yi-Pai Huang, Zhubei (TW); Justin A Meiners, Boulder, CO (US)

(21) Appl. No.: 18/653,567

(22) Filed: May 2, 2024

Related U.S. Application Data
(60) Provisional application No. 63/509,501, filed on Jun. 21, 2023.

(51) Int. Cl. G06T 15/06; H04N 13/133; H04N 13/305

(52) U.S. Cl. CPC G06T 15/06; H04N 13/133; H04N 13/305

(57) ABSTRACT

An electronic device may include a lenticular display. The lenticular display may have a lenticular lens film formed over an array of pixels. The lenticular lenses may be configured to enable stereoscopic viewing of the display such that a viewer perceives three-dimensional images. The display may render different content layers that present different classes of content. The different classes of content may have different characteristics. As an example, a first class of content may be static content whereas a second class of content may be dynamic content. The different characteristics of each class of content may be leveraged to use a hybrid approach for content processing. The hybrid content processing may take advantage of different layers needing to be updated at different frequencies and may take advantage of sparse content in some of the layers.

This application claims the benefit of U.S. provisional patent application No. 63/509,501 filed Jun. 21, 2023, which is hereby incorporated by reference herein in its entirety.

### FIELD

This relates generally to electronic devices, and, more particularly, to electronic devices with displays.

### BACKGROUND

Electronic devices often include displays. In some cases, displays may include lenticular lenses that enable the display to provide three-dimensional content to the viewer. The lenticular lenses may be formed over an array of pixels such as organic light-emitting diode pixels or liquid crystal display pixels.

### SUMMARY

A method of operating a stereoscopic display with an array of display pixels may include rendering first content for a first layer and second content for a second layer, mapping the first content to the array of display pixels using a stored calibration map, and, for each frame in the second content: ray tracing to determine a respective calibration map for that frame and mapping the second content to the array of display pixels using the respective calibration map for that frame.

An electronic device may include an array of display pixels that presents images in sequential frames, lenticular lenses formed over the array of display pixels, a cache that is configured to store mapped background content for the array of display pixels, a frame buffer that is configured to, for each one of the sequential frames, receive the mapped background content from the cache and dynamic content that is mapped based on ray tracing, and display driver circuitry configured to receive an array of brightness values for the array of display pixels from the frame buffer and drive the array of display pixels using the array of brightness values.

An electronic device may include an array of display pixels, lenticular lenses formed over the array of display pixels, and ray tracing circuitry that is configured to: receive first rendered content at a first frequency, output a first calibration map associated with the first rendered content at the first frequency, receive second rendered content at a second frequency that is greater than the first frequency, and output a second calibration map associated with the second rendered content at the second frequency.

### BRIEF DESCRIPTION OF THE DRAWINGS

FIG. 1 is a schematic diagram of an illustrative electronic device having a display in accordance with some embodiments.

FIG. 2 is a top view of an illustrative display in an electronic device in accordance with some embodiments.

FIG. 3 is a cross-sectional side view of an illustrative lenticular display that provides images to a viewer in accordance with some embodiments.

FIG. 4 is a cross-sectional side view of an illustrative lenticular display that provides images to two or more viewers in accordance with some embodiments.

FIG. 5 is a top view of an illustrative lenticular lens film showing the elongated shape of the lenticular lenses in accordance with some embodiments.

FIG. 6 is a diagram of an illustrative display that includes an eye and/or head tracking system that determines viewer eye position and control circuitry that updates the display based on the viewer eye position in accordance with some embodiments.

FIGS. 7A-7C are perspective views of illustrative three-dimensional content that may be displayed on different zones of a display in accordance with some embodiments.

FIG. 8 is a side view of an illustrative display that presents multiple layers of content at different perceived depths in accordance with some embodiments.

FIG. 9 is a side view of an illustrative display showing ray tracing operations for the display in accordance with some embodiments.

FIG. 10 is a top view of an illustrative content layer that includes rotational content in accordance with some embodiments.

FIG. 11 is a top view of an illustrative content layer that includes dynamic content in accordance with some embodiments.

FIG. 12 is a side view of an illustrative display that presents a content layer and a corresponding bounding box on the display panel for that content layer in accordance with some embodiments.

FIG. 13 is a schematic diagram for an illustrative electronic device with hybrid processing of rendered content in accordance with some embodiments.

FIG. 14 is a diagram showing how ray tracing may be used to determine an intersection point on multiple planes at multiple depths in accordance with some embodiments.

### DETAILED DESCRIPTION

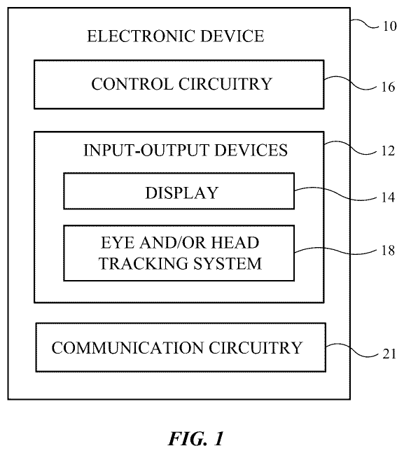

An illustrative electronic device of the type that may be provided with a display is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, an augmented reality (AR) headset and/or virtual reality (VR) headset, a device embedded in eyeglasses or other equipment worn on a user's head, or other wearable or miniature device, a display, a computer display that contains an embedded computer, a computer display that does not contain an embedded computer, a gaming device, a navigation device, an embedded system such as a system in which electronic equipment with a display is mounted in a kiosk or automobile, or other electronic equipment.

As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

To support communications between device 10 and external equipment, control circuitry 16 may communicate using communications circuitry 21. Circuitry 21 may include antennas, radio-frequency transceiver circuitry, and other wireless communications circuitry and/or wired communications circuitry. Circuitry 21, which may sometimes be referred to as control circuitry and/or control and communications circuitry, may support bidirectional wireless communications between device 10 and external equipment over a wireless link (e.g., circuitry 21 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link). Wireless communications may, for example, be supported over a Bluetooth® link, a WiFi® link, a 60GHz link or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, sensors, light-emitting diodes and other status indicators, data ports, and other electrical components. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements.

Some electronic devices may include two displays. In one possible arrangement, a first display may be positioned on one side of the device and a second display may be positioned on a second, opposing side of the device. The first and second displays therefore may have a back-to-back arrangement. One or both of the displays may be curved.

Sensors in input-output devices 12 may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into display 14, a two-dimensional capacitive touch sensor overlapping display 14, and/or a touch sensor that forms a button, trackpad, or other input device not associated with a display), and other sensors. If desired, sensors in input-output devices 12 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, gaze tracking sensors, and/or other sensors.

Control circuitry 16 may be used to run software on device 10 such as operating system code and applications. During operation of device 10, the software running on control circuitry 16 may display images on display 14 using an array of pixels in display 14.

Display 14 may be an organic light-emitting diode display, a liquid crystal display, an electrophoretic display, an electrowetting display, a plasma display, a microelectromechanical systems display, a display having a pixel array formed from crystalline semiconductor light-emitting diode dies (sometimes referred to as microLEDs), and/or other display. Configurations in which display 14 is an organic light-emitting diode display are sometimes described herein as an example.

Display 14 may have a rectangular shape (i.e., display 14 may have a rectangular footprint and a rectangular peripheral edge that runs around the rectangular footprint) or may have other suitable shapes. Display 14 may be planar or may have a curved profile.

Device 10 may include cameras and other components that form part of gaze and/or head tracking system 18. The camera(s) or other components of system 18 may face an expected location for a viewer and may track the viewer's eyes and/or head (e.g., images and other information captured by system 18 may be analyzed by control circuitry 16 to determine the location of the viewer's eyes and/or head). This head-location information obtained by system 18 may be used to determine the appropriate direction with which display content from display 14 should be directed. Eye and/or head tracking system 18 may include any desired number/combination of infrared and/or visible light detectors. Eye and/or head tracking system 18 may optionally include light emitters to illuminate the scene.

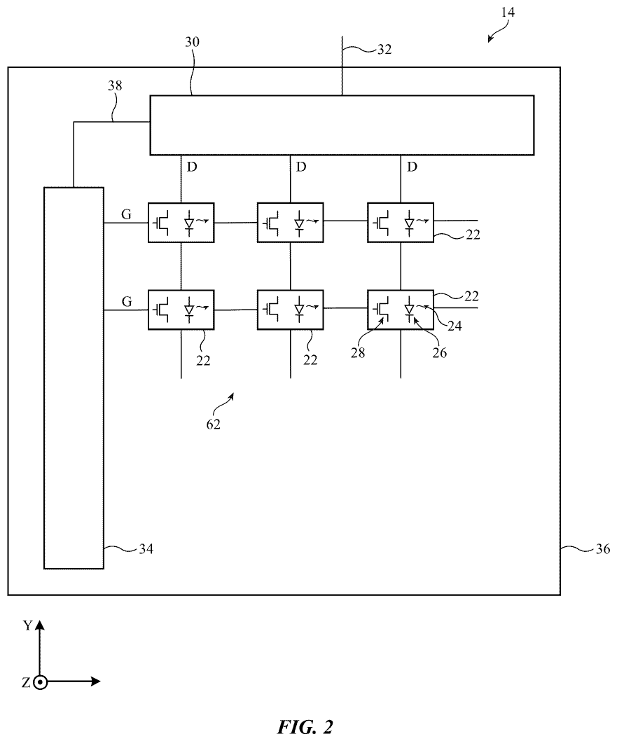

A top view of a portion of display 14 is shown in FIG. 2. As shown in FIG. 2, display 14 may have an array of pixels 22 formed on substrate 36. Substrate 36 may be formed from glass, metal, plastic, ceramic, or other substrate materials. Pixels 22 may receive data signals over signal paths such as data lines D and may receive one or more control signals over control signal paths such as horizontal control lines G (sometimes referred to as gate lines, scan lines, emission control lines, etc.). There may be any suitable number of rows and columns of pixels 22 in display 14 (e.g., tens or more, hundreds or more, or thousands or more). Each pixel 22 may have a light-emitting diode 26 that emits light 24 under the control of a pixel circuit formed from thin-film transistor circuitry (such as thin-film transistors 28 and thin-film capacitors). Thin-film transistors 28 may be polysilicon thin-film transistors, semiconducting-oxide thin-film transistors such as indium gallium zinc oxide transistors, or thin-film transistors formed from other semiconductors. Pixels 22 may contain light-emitting diodes of different colors (e.g., red, green, and blue diodes for red, green, and blue pixels, respectively) to provide display 14 with the ability to display color images.

Display driver circuitry may be used to control the operation of pixels 22. The display driver circuitry may be formed from integrated circuits, thin-film transistor circuits, or other suitable circuitry. Display driver circuitry 30 of FIG. 2 may contain communications circuitry for communicating with system control circuitry such as control circuitry 16 of FIG. 1 over path 32. Path 32 may be formed from traces on a flexible printed circuit or other cable. During operation, the control circuitry (e.g., control circuitry 16 of FIG. 1) may supply circuitry 30 with information on images to be displayed on display 14.

To display the images on display pixels 22, display driver circuitry 30 may supply image data to data lines D while issuing clock signals and other control signals to supporting display driver circuitry such as gate driver circuitry 34 over path 38. If desired, circuitry 30 may also supply clock signals and other control signals to gate driver circuitry on an opposing edge of display 14.

Gate driver circuitry 34 (sometimes referred to as horizontal control line control circuitry) may be implemented as part of an integrated circuit and/or may be implemented using thin-film transistor circuitry. Horizontal control lines G in display 14 may carry gate line signals (scan line signals), emission enable control signals, and other horizontal control signals for controlling the pixels of each row. There may be any suitable number of horizontal control signals per row of pixels 22 (e.g., one or more, two or more, three or more, four or more, etc.).

Display 14 may sometimes be a stereoscopic display that is configured to display three-dimensional content for a viewer. Stereoscopic displays are capable of displaying multiple two-dimensional images that are viewed from slightly different angles. When viewed together, the combination of the two-dimensional images creates the illusion of a three-dimensional image for the viewer. For example, a viewer's left eye may receive a first two-dimensional image and a viewer's right eye may receive a second, different two-dimensional image. The viewer perceives these two different two-dimensional images as a single three-dimensional image.

There are numerous ways to implement a stereoscopic display. Display 14 may be a lenticular display that uses lenticular lenses (e.g., elongated lenses that extend along parallel axes), may be a parallax barrier display that uses parallax barriers (e.g., an opaque layer with precisely spaced slits to create a sense of depth through parallax), may be a volumetric display, or may be any other desired type of stereoscopic display. Configurations in which display 14 is a lenticular display are sometimes described herein as an example.

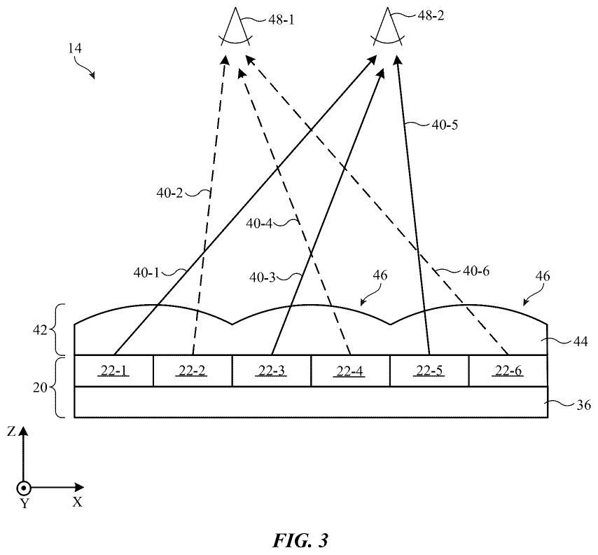

FIG. 3 is a cross-sectional side view of an illustrative lenticular display that may be incorporated into electronic device 10. Display 14 includes a display panel 20 with pixels 22 on substrate 36. Substrate 36 may be formed from glass, metal, plastic, ceramic, or other substrate materials and pixels 22 may be organic light-emitting diode pixels, liquid crystal display pixels, or any other desired type of pixels.

As shown in FIG. 3, lenticular lens film 42 may be formed over the display pixels. Lenticular lens film 42 (sometimes referred to as a light redirecting film, a lens film, etc.) includes lenses 46 and a base film portion 44 (e.g., a planar film portion to which lenses 46 are attached). Lenses 46 may be lenticular lenses that extend along respective longitudinal axes (e.g., axes that extend into the page parallel to the Y-axis). Lenses 46 may be referred to as lenticular elements 46, lenticular lenses 46, optical elements 46, etc.

The lenses 46 of the lenticular lens film cover the pixels of display 14. An example is shown in FIG. 3 with display pixels 22-1, 22-2, 22-3, 22-4, 22-5, and 22-6. In this example, display pixels 22-1 and 22-2 are covered by a first lenticular lens 46, display pixels 22-3 and 22-4 are covered by a second lenticular lens 46, and display pixels 22-5 and 22-6 are covered by a third lenticular lens 46. The lenticular lenses may redirect light from the display pixels to enable stereoscopic viewing of the display.

Consider the example of display 14 being viewed by a viewer with a first eye (e.g., a right eye) 48-1 and a second eye (e.g., a left eye) 48-2. Light from pixel 22-1 is directed by the lenticular lens film in direction 40-1 towards left eye 48-2, light from pixel 22-2 is directed by the lenticular lens film in direction 40-2 towards right eye 48-1, light from pixel 22-3 is directed by the lenticular lens film in direction 40-3 towards left eye 48-2, light from pixel 22-4 is directed by the lenticular lens film in direction 40-4 towards right eye 48-1, light from pixel 22-5 is directed by the lenticular lens film in direction 40-5 towards left eye 48-2, light from pixel 22-6 is directed by the lenticular lens film in direction 40-6 towards right eye 48-1. In this way, the viewer's right eye 48-1 receives images from pixels 22-2, 22-4, and 22-6, whereas left eye 48-2 receives images from pixels 22-1, 22-3, and 22-5. Pixels 22-2, 22-4, and 22-6 may be used to display a slightly different image than pixels 22-1, 22-3, and 22-5. Consequently, the viewer may perceive the received images as a single three-dimensional image.

Pixels of the same color may be covered by a respective lenticular lens 46. In one example, pixels 22-1 and 22-2 may be red pixels that emit red light, pixels 22-3 and 22-4 may be green pixels that emit green light, and pixels 22-5 and 22-6 may be blue pixels that emit blue light. This example is merely illustrative. In general, each lenticular lens may cover any desired number of pixels each having any desired color. The lenticular lens may cover a plurality of pixels having the same color, may cover a plurality of pixels each having different colors, may cover a plurality of pixels with some pixels being the same color and some pixels being different colors, etc.

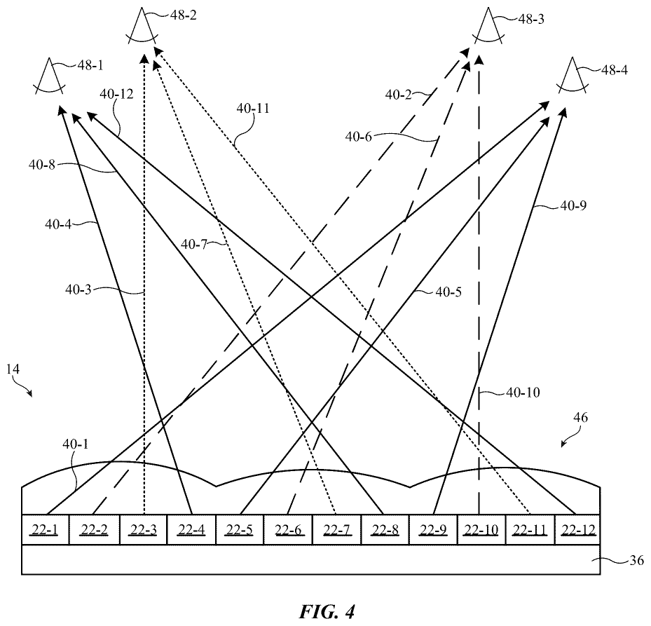

FIG. 4 is a cross-sectional side view of an illustrative stereoscopic display showing how the stereoscopic display may be viewable by multiple viewers. The stereoscopic display of FIG. 3 may have one optimal viewing position (e.g., one viewing position where the images from the display are perceived as three-dimensional). The stereoscopic display of FIG. 4 may have two or more optimal viewing positions (e.g., two or more viewing positions where the images from the display are perceived as three-dimensional).

Display 14 may be viewed by both a first viewer with a right eye 48-1 and a left eye 48-2 and a second viewer with a right eye 48-3 and a left eye 48-4. Light from pixel 22-1 is directed by the lenticular lens film in direction 40-1 towards left eye 48-4, light from pixel 22-2 is directed by the lenticular lens film in direction 40-2 towards right eye 48-3, light from pixel 22-3 is directed by the lenticular lens film in direction 40-3 towards left eye 48-2, light from pixel 22-4 is directed by the lenticular lens film in direction 40-4 towards right eye 48-1, light from pixel 22-5 is directed by the lenticular lens film in direction 40-5 towards left eye 48-4, light from pixel 22-6 is directed by the lenticular lens film in direction 40-6 towards right eye 48-3, light from pixel 22-7 is directed by the lenticular lens film in direction 40-7 towards left eye 48-2, light from pixel 22-8 is directed by the lenticular lens film in direction 40-8 towards right eye 48-1, light from pixel 22-9 is directed by the lenticular lens film in direction 40-9 towards left eye 48-4, light from pixel 22-10 is directed by the lenticular lens film in direction 40-10 towards right eye 48-3, light from pixel 22-11 is directed by the lenticular lens film in direction 40-11 towards left eye 48-2, and light from pixel 22-12 is directed by the lenticular lens film in direction 40-12 towards right eye 48-1. In this way, the first viewer's right eye 48-1 receives images from pixels 22-4, 22-8, and 22-12, whereas left eye 48-2 receives images from pixels 22-3, 22-7, and 22-11. Pixels 22-4, 22-8, and 22-12 may be used to display a slightly different image than pixels 22-3, 22-7, and 22-11. Consequently, the first viewer may perceive the received images as a single three-dimensional image. Similarly, the second viewer's right eye 48-3 receives images from pixels 22-2, 22-6, and 22-10, whereas left eye 48-4 receives images from pixels 22-1, 22-5, and 22-9. Pixels 22-2, 22-6, and 22-10 may be used to display a slightly different image than pixels 22-1, 22-5, and 22-9. Consequently, the second viewer may perceive the received images as a single three-dimensional image.

Pixels of the same color may be covered by a respective lenticular lens 46. In one example, pixels 22-1, 22-2, 22-3, and 22-4 may be red pixels that emit red light, pixels 22-5, 22-6, 22-7, and 22-8 may be green pixels that emit green light, and pixels 22-9, 22-10, 22-11, and 22-12 may be blue pixels that emit blue light. This example is merely illustrative. The display may be used to present the same three-dimensional image to both viewers or may present different three-dimensional images to different viewers. In some cases, control circuitry in the electronic device 10 may use eye and/or head tracking system 18 to track the position of one or more viewers and display images on the display based on the detected position of the one or more viewers.

It should be understood that the lenticular lens shapes and directional arrows of FIGS. 3 and 4 are merely illustrative. The actual rays of light from each pixel may follow more complicated paths (e.g., with redirection occurring due to refraction, total internal reflection, etc.). Additionally, light from each pixel may be emitted over a range of angles. The lenticular display may also have lenticular lenses of any desired shape or shapes. Each lenticular lens may have a width that covers two pixels, three pixels, four pixels, more than four pixels, more than ten pixels, etc. Each lenticular lens may have a length that extends across the entire display (e.g., parallel to columns of pixels in the display).

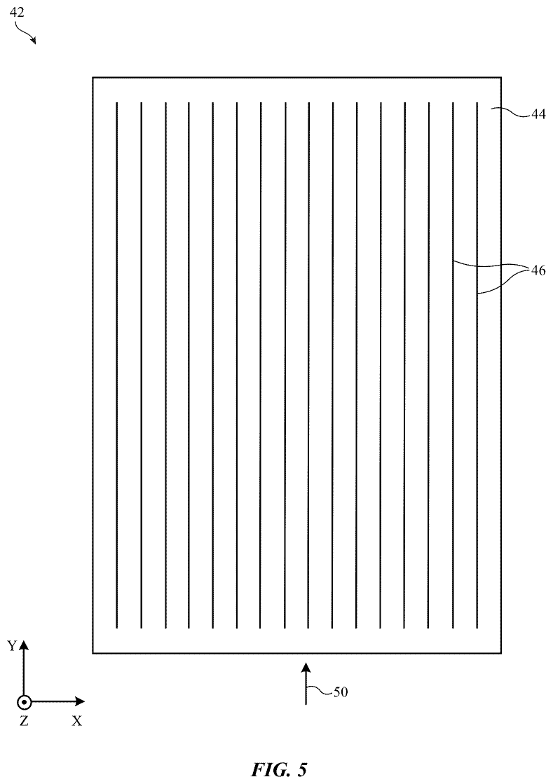

FIG. 5 is a top view of an illustrative lenticular lens film that may be incorporated into a lenticular display. As shown in FIG. 5, elongated lenses 46 extend across the display parallel to the Y-axis. For example, the cross-sectional side view of FIGS. 3 and 4 may be taken looking in direction 50. The lenticular display may include any desired number of lenticular lenses 46 (e.g., more than 10, more than 100, more than 1,000, more than 10,000, etc.). In FIG. 5, the lenticular lenses extend perpendicular to the upper and lower edge of the display panel. This arrangement is merely illustrative, and the lenticular lenses may instead extend at a non-zero, non-perpendicular angle (e.g., diagonally) relative to the display panel if desired.

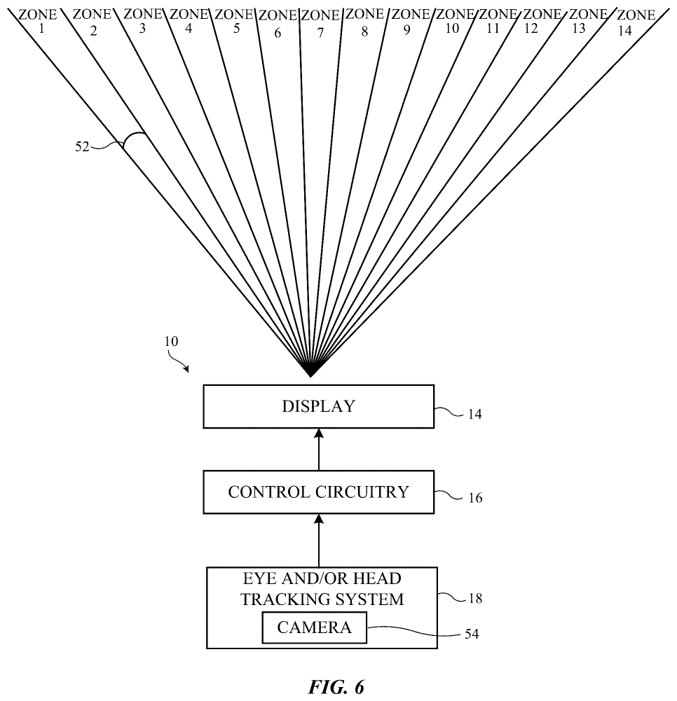

FIG. 6 is a schematic diagram of an illustrative electronic device showing how information from eye and/or head tracking system 18 may be used to control operation of the display. As shown in FIG. 6, display 14 is capable of providing unique images across a number of distinct zones. In FIG. 6, display 14 emits light across 14 zones, each having a respective angle of view 52. The angle 52 may be between 1 degrees and 2 degrees, between 0 degrees and 4 degrees, less than 5 degrees, less than 3 degrees, less than 2 degrees, less than 1.5 degrees, between 1 degree and 4 degrees, greater than 0.5 degrees, or any other desired angle. Each zone may have the same associated viewing angle or different zones may have different associated viewing angles.

The example herein of the display having 14 independently controllable zones is merely illustrative. In general, the display may have any desired number of independently controllable zones (e.g., more than 2, more than 6, more than 10, more than 12, more than 16, more than 20,more than 30, more than 40, less than 40, between 10 and 30, between 12 and 25, etc.).

Each zone is capable of displaying a unique image to the viewer. The sub-pixels on display 14 may be divided into groups, with each group of sub-pixels capable of displaying an image for a particular zone. For example, a first subset of sub-pixels in display 14 is used to display an image (e.g., a two-dimensional image) for zone 1, a second subset of sub-pixels in display 14 is used to display an image for zone 2, a third subset of sub-pixels in display 14 is used to display an image for zone 3, etc. In other words, the sub-pixels in display 14 may be divided into 14 groups, with each group associated with a corresponding zone (sometimes referred to as viewing zone) and capable of displaying a unique image for that zone. The sub-pixel groups may also themselves be referred to as zones.

Control circuitry 16 may control display 14 to display desired images in each viewing zone. There is much flexibility in how the display provides images to the different viewing zones. Display 14 may display entirely different content in different zones of the display. For example, an image of a first object (e.g., a cube) is displayed for zone 1, an image of a second, different object (e.g., a pyramid) is displayed for zone 2, an image of a third, different object (e.g., a cylinder) is displayed for zone 3, etc. This type of scheme may be used to allow different viewers to view entirely different scenes from the same display. However, in practice there may be crosstalk between the viewing zones. As an example, content intended for zone 3 may not be contained entirely within viewing zone 3 and may leak into viewing zones 2 and 4.

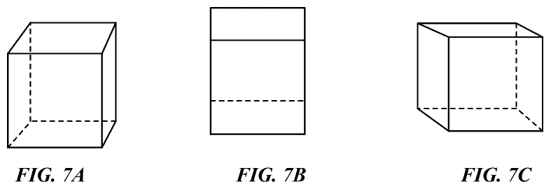

Therefore, in another possible use-case, display 14 may display a similar image for each viewing zone, with slight adjustments for perspective between each zone. This may be referred to as displaying the same content at different perspectives, with one image corresponding to a unique perspective of the same content. For example, consider an example where the display is used to display a three-dimensional cube. The same content (e.g., the cube) may be displayed on all of the different zones in the display. However, the image of the cube provided to each viewing zone may account for the viewing angle associated with that particular zone. In zone 1, for example, the viewing cone may be at a-10° angle relative to the surface normal of the display. Therefore, the image of the cube displayed for zone 1 may be from the perspective of a −10° angle relative to the surface normal of the cube (as in FIG. 7A). Zone 7, in contrast, is at approximately the surface normal of the display. Therefore, the image of the cube displayed for zone 7 may be from the perspective of a 0° angle relative to the surface normal of the cube (as in FIG. 7B). Zone 14 is at a 10° angle relative to the surface normal of the display. Therefore, the image of the cube displayed for zone 14 may be from the perspective of a 10° angle relative to the surface normal of the cube (as in FIG. 7C). As a viewer progresses from zone 1 to zone 14 in order, the appearance of the cube gradually changes to simulate looking at a real-world object.

There are many possible variations for how display 14 displays content for the viewing zones. In general, each viewing zone may be provided with any desired image based on the application of the electronic device. Different zones may provide different images of the same content at different perspectives, different zones may provide different images of different content, etc.

In one possible scenario, one or more of the zones may be disabled based on information from the eye and/or head tracking system 18. Alternatively, display 14 may display images for all of the viewing zones at the same time. In other words, the display may operate without factoring in viewer position. When operating without factoring in viewer position, all of the viewing zones may be kept on (so that the viewer sees images regardless of their position).

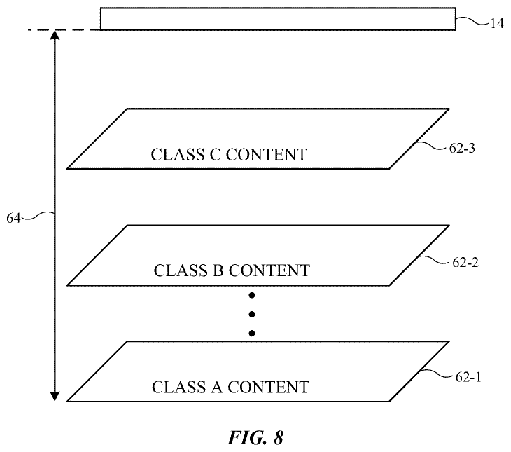

Lenticular display 14 may be used to display different layers of content. FIG. 8 is a side view showing how display 14 may be used to present different layers of content at different perceived depths underneath display 14. FIG. 8 shows an example where display 14 presents a first layer 62-1 at a first depth 64 relative to display panel 14, a second layer 62-2 at a second depth relative to display panel 14, and a third layer 62-3 at a third depth relative to display panel 14.

Target content for each layer 62 (sometimes referred to as content layers 62) may be rendered by circuitry within electronic device 10. Processing may then be performed to determine how to present the rendered content using the lenticular display. The processing that may be used to determine how to present the rendered content using the lenticular display may include pixel mapping operations and/or ray tracing operations.

Pixel mapping operations may use a display calibration map that indicates how each view corresponds to the pixel array. The display calibration map may identify a first subset of pixels in the pixel array that is visible at viewing zone 1, a second subset of pixels in the pixel array that is visible at viewing zone 2, a third subset of pixels in the pixel array that is visible at viewing zone 3, etc. The display calibration map may be fixed (e.g., unchanging or static) during pixel mapping operations. A two-dimensional image may be rendered for each respective viewing zone in the display. The display calibration map may be used to map target content for each viewing zone to corresponding pixels associated with that viewing zone (according to the display calibration map). In this example, the display calibration may be determined during calibration operations for electronic device 10 and is stored in electronic device 10 for subsequent pixel mapping operations.

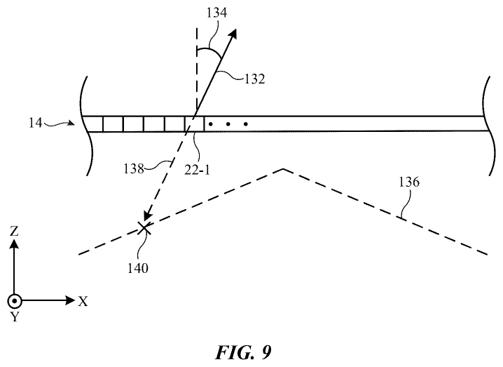

Another example of processing that may be performed to determine how to present rendered content using the lenticular display is ray tracing operations. FIG. 9 is a side view of display 14 showing how the ray tracing process may be performed. As shown, a given sub-pixel 22-1 within display 14 may emit light in direction 132 (e.g., after the light is deflected by the lenticular lenses 42 as previously shown). Direction 132 may be at an angle 134 relative to a reference direction (e.g., the surface normal of the lenticular display or another desired reference direction). Each sub-pixel may have an associated direction 132 and angle 134. The angle 134 (sometimes referred to as deflection angle 134, horizontal deflection angle 134, etc.) for each sub-pixel is stored in a deflection measurements database. The deflection measurements may be obtained during calibration operations during manufacturing electronic device 10, as one example. The deflection measurements may be obtained using display calibration parameters such as lens pitch, pixel size, lens alignment, etc.

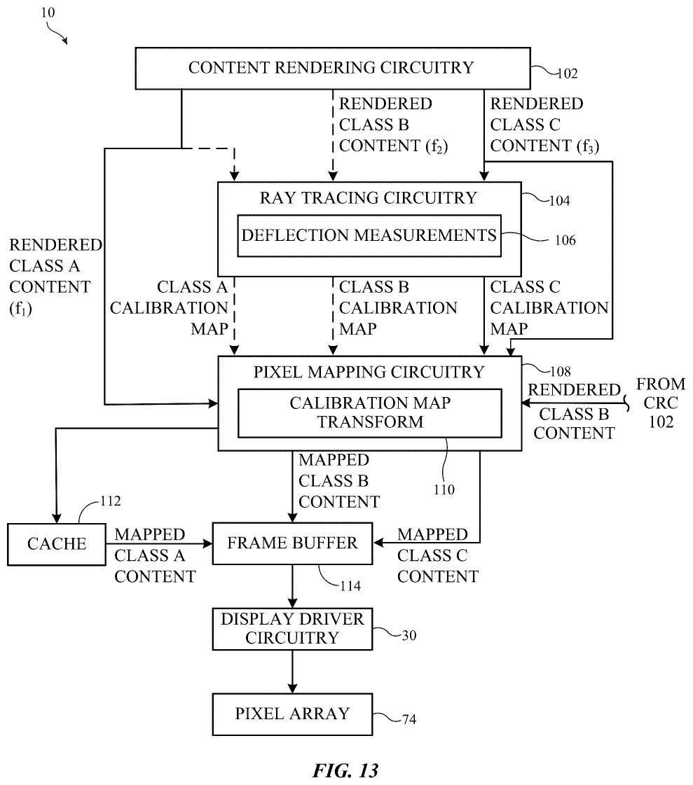

FIG. 9 shows how display 14 may intend to display a three-dimensional surface 136. The target three-dimensional surface may be obtained, for example, from a rendered three-dimensional image (texture). Ray tracing circuitry (such as ray tracing circuitry 104 in FIG. 13) in the display may, for each sub-pixel in display 14, trace a ray 138 in the opposite direction of the outgoing direction 132 for that sub-pixel. In this way, the ray tracing circuitry simulates how a viewer perceives the light from that sub-pixel. The ray tracing circuitry may, for each sub-pixel in display 14, determine the point 140 on three-dimensional surface 136 that is intersected by ray 138. The ray tracing circuitry may also know the correlation between a location on the three-dimensional surface (of the given content) 136 and a corresponding location on the corresponding two-dimensional image (of the given content).

The ray tracing circuitry may output a display calibration map that includes, for each sub-pixel in display 14, the location of a corresponding point on the two-dimensional image of the given content (e.g., the 2D image received by the ray tracing circuitry). In other words, the display calibration map may be continuously updated to account for the topology associated with three-dimensional surface 136.

Using ray tracing operations instead of pixel mapping operations may allow the displayed images to be better optimized and mitigates crosstalk in the three-dimensional images displayed by lenticular display 14. However, ray tracing may be processing intensive. Performing ray tracing operations for all of content layers 62 may therefore require more processing power than desired.

The content in layers 62-1, 62-2, and 62-3 may ultimately be superimposed on each other and simultaneously displayed using lenticular display 14. However, different layers may be rendered and processed in different ways to optimize processing power requirements and display artifacts for the lenticular display.

In particular, each layer may be used to present a different type of content. As shown in FIG. 8, layer 62-1 presents class A content, layer 62-2 presents class B content, and layer 62-3 presents class C content. Each class of content may have different characteristics.

Class A content may include background content that is updated infrequently. In other words, the class A content may be static/unchanging for long periods of time. The refresh rate for the rendered background content may therefore be relatively low.

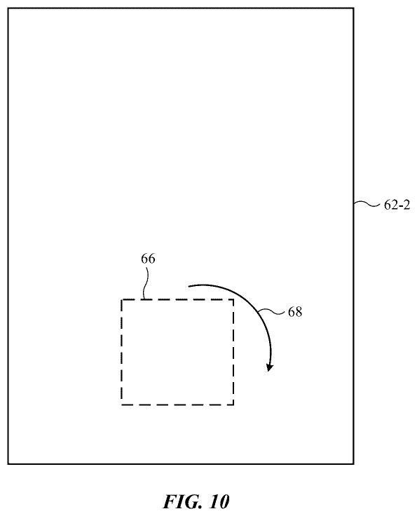

Class B content may include content that has at least one attribute (e.g., appearance in texture, color, and/or brightness) that changes over time. However, at least one attribute of the class B content may be fixed over time. One example of this type is shown in FIG. 10, with content 66 (sometimes referred to as rotational content) on layer 62-2. The rotation-agnostic appearance of the content 66 remains static/unchanging for long periods of time. However, the content is consistently rotated (e.g., in direction 68 in FIG. 10). Rotation is just one example of the type of update that may be performed on content 66. As other examples, content 66 may be stretched (with clipping at a boundary so the overall footprint of the content remains the same) and/or there may be a circular translation in texture appearance applied to content 66.

Another example of class B content is sprite animation content, where the texture of the content includes a sequence of frames that are stitched to a single elongated texture and each frame references a different section of the single elongated texture.

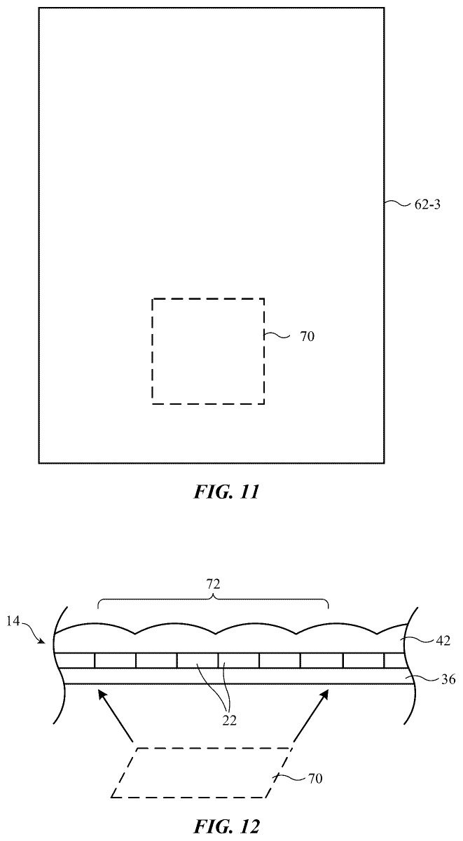

Class C content may include content that is updated frequently (e.g., content that changes in appearance and/or geometry frequently and/or that moves around the display frequently). An example of this type is shown in FIG. 11, with dynamic content 70 on layer 62-3. In other words, the appearance of dynamic content 70 may change frequently and/or the position of dynamic content 70 on layer 62-3 may change frequently. The refresh rate for the dynamic content may therefore be relatively high.

As shown in, for example, FIGS. 10 and 11, the content of a given layer may occupy a small area of the overall display. In other words, the footprint of content 66 in FIG. 10 may be relatively small (e.g., less than 50% the footprint of the display, less than 25% the footprint of the display, less than 10% the footprint of the display, less than 5% the footprint of the display, etc.). Similarly, the footprint of dynamic content 70 in FIG. 11 may be relatively small (e.g., less than 50% the footprint of the display, less than 25% the footprint of the display, less than 10% the footprint of the display, less than 5% the footprint of the display, etc.).

When sparse content is present in a content layer, the small overall footprint of the sparse content may be leveraged to improve processing requirements. FIG. 12 shows an example where dynamic content 70 is associated with a bounding box 72. Bounding box 72 is a footprint on display panel 14 that is larger than the footprint of the corresponding content 70. The bounding box 72 may account for the maximum footprint on display 14 that needs to be updated when accounting for the footprint of content 70 and the perceived depth of content 70 relative to the lenticular display. Content with a larger perceived depth may have a larger associated bounding box whereas content with a smaller perceived depth may have a smaller associated bounding box. In some cases, a single content layer may have multiple discrete content footprints with corresponding bounding boxes. In general, only pixels within the bounding box(es) may be processed during processing of a given content layer. The bounding box may be applied to class B content, class C content, and any other desired content that occupies only a subset of the display.

The different characteristics of each class of content may be leveraged to use a hybrid approach for content processing. The hybrid content processing may take advantage of different layers needing to be updated at different frequencies, may take advantage of the sparse content in some of the layers, etc.

First, consider the frequency at which each layer updates. The class A content may be updated infrequently. The duration of time between updates of the class A content may be greater than 1 second, greater than 10 seconds, greater than 1 minute, etc. Content rendering circuitry in electronic device 10 may only render the class A content at a low frequency and/or as needed (with large gaps between sequential renderings).

The class C content may be updated frequently. The duration of time between updates of the class C content may be less than 1 second, less than 100 milliseconds, less than 10 milliseconds, less than 1 millisecond, etc. Content rendering circuitry in electronic device 10 may render the class C content at a high frequency (e.g., 60 Hz, 120 Hz, 240 Hz, greater than or equal to 1 Hz, greater than or equal to 60 Hz, greater than or equal to 120 Hz, etc.).

Due to the one or more attributes that remain fixed over time, the class B content may be updated infrequently. The duration of time between updates of the class B content may be greater than 1 second, greater than 10 seconds, greater than 1 minute, etc. Content rendering circuitry in electronic device 10 may only render the class B content at a low frequency and/or as needed (with large gaps between sequential renderings).

FIG. 13 is a schematic diagram of electronic device 10. As shown, electronic device 10 includes content rendering circuitry 102. Content rendering circuitry 102 may be configured to render or generate virtual content or may be used to carry out other graphics processing functions.

As previously discussed, content rendering circuitry 102 may output content in a plurality of discrete layers. Each layer may have an associated three-dimensional surface such as surface 136 in FIG. 9 in addition to a two-dimensional image that is associated with the three-dimensional surface. Additional processing circuitry in the electronic device such as ray tracing circuitry 104 and pixel mapping circuitry 108 may be used to determine how to control each sub-pixel in the lenticular display such that the content is perceived as three-dimensional content at the target depth and with the target appearance.

Because each layer is used to present a different class of content with unique properties, the different layers of content may be processed differently by ray tracing circuitry 104 and/or pixel mapping circuitry 108.

First, consider class A content. The class A content is typically static. In other words, the three-dimensional surface associated with the content and the appearance of the image on the three-dimensional surface are both static. The class A content may include background content that does not change over time. Examples of class A content include a watch face (e.g., the numbers, tick marks, and other features of a watch face that are unchanging over time), an unchanging background landscape or photograph, etc.

The rendered class A content may be updated at a first frequency f₁. Frequency f₁ may be relatively low (e.g., less than 1 Hz, less than 0.1 Hz, etc.). Instead or in addition, the class A content may be rendered intermittently at an irregular rate. For example, the class A content may not be rendered unless there is an update in the interface that triggers an update to the class A content.

As shown in FIG. 13, the rendered class A content may be provided to pixel mapping circuitry 108. The pixel mapping circuitry 108 may use a class A calibration map associated with the class A content to map the class A content to sub-pixels on display 14. The class A calibration map may be determined during calibration operations for electronic device 10 and stored in pixel mapping circuitry 108. Alternatively, the class A calibration map may be obtained by ray tracing circuitry 104. As previously discussed, ray tracing circuitry 104 uses deflection measurements 106 to output a display calibration map that includes, for each sub-pixel in display 14, the location of a corresponding point on the two-dimensional image of the given content (e.g., the 2D image of the class A content). In other words, the display calibration map is updated to account for the topology associated with surface 136 for the class A content.

Because the topology associated with surface 136 for the class A content is, generally, fixed, the ray tracing operations may only be performed once for the class A content. Consider an example where the class A content includes a first background having a first three-dimensional topology and a first two-dimensional appearance. Ray tracing circuitry 104 may be used to generate a class A calibration map associated with the first three-dimensional topology. The pixel mapping circuitry 108 may then use the class A calibration map to map the first two-dimensional appearance to the three-dimensional topology in the display domain (e.g., with a brightness value for each sub-pixel in display 14).

The first background may then change to a second background having the first three-dimensional topology and a second two-dimensional appearance (e.g., different colors). Because the three-dimensional topology is unchanged, ray tracing circuity 104 need not remake the class A calibration map. Pixel mapping circuitry 108 may use the same class A calibration map to map the second two-dimensional appearance to the first three-dimensional topology in the display domain (e.g., with a brightness value for each sub-pixel in display 14).

The second background may then change to a third background having a second three-dimensional topology and a third two-dimensional appearance. Because the three-dimensional topology has changed (e.g., changed to a different three-dimensional depth, tilted, and/or changed in three-dimensional shape), ray tracing circuity 104 may output a new class A calibration map to pixel mapping circuitry 108. Pixel mapping circuitry 108 may use the new class A calibration map to map the third two-dimensional appearance to the second three-dimensional topology in the display domain (e.g., with a brightness value for each sub-pixel in display 14).

There is therefore a processing power savings associated with only performing ray tracing for the background content when the three-dimensional topology of the background content changes. Content may be rendered and then mapped by pixel mapping circuitry 108 without performing ray tracing operations between the rendering and mapping operations.

Pixel mapping circuitry 108 may output the mapped class A content to a cache 112. Cache 112 may be any desired type of memory in control circuitry 16, for example. Subsequently, during each display frame, the class A content may be pulled from cache 112 to a frame buffer 114 where the class A content is combined with other content types to obtain a unitary array of brightness values that is presented on lenticular display 14.

Next, consider class B content. Class B content may include content that is updated frequently (e.g., by being rotated, stretched, and/or having a circular translation of texture). In one possible arrangement, the three-dimensional topology for the class B content is static but the two-dimensional appearance of the class B content is continuously rotated over time. The three-dimensional topology for the class B content may also optionally continuously rotate over time. Examples of class B content include a watch subdial, rotating game content, or other rotating content.

The rendered class B content may be updated at a second frequency f₂. Frequency f₂ may be greater than, less than, or equal to f₁ for the class A content. Instead or in addition, the class B content may be rendered intermittently at an irregular rate. For example, the class B content may not be rendered unless there is an update in the interface that triggers an update to the class B content.

As shown in FIG. 13, the rendered class B content may be provided to pixel mapping circuitry 108. The pixel mapping circuitry 108 may use a class B calibration map associated with the class B content to map the class B content to sub-pixels on display 14. In arrangements where the class B content has a fixed position on display 14, the class B calibration map may be determined during calibration operations for electronic device 10 and stored in pixel mapping circuitry 108. Alternatively, the class B calibration map may be obtained by ray tracing circuitry 104. As previously discussed, ray tracing circuitry 104 uses deflection measurements 106 to output a display calibration map that includes, for each sub-pixel in display 14, the location of a corresponding point on the two-dimensional image of the given content (e.g., the 2D image of the class B content). In other words, the display calibration map is updated to account for the topology associated with surface 136 for the class B content.

The pixel mapping circuitry may apply a transform 110 (sometimes referred to as a calibration map transform 110, rotational transform 110, etc.) to the rendered class B content during mapping operations. The calibration map transform may be applied to the class B calibration map or to the rendered class B content itself. The calibration map transform may, with each application, rotate the class B content by a fixed amount. The rotated class B content may then be used as the input for the next calibration map transform, causing the content to continuously rotate over time (e.g., clockwise as in FIG. 10).

Pixel mapping circuitry 108 may output the mapped class B content to frame buffer 114. During each display frame, the class B content may be superimposed on the class A content from cache 112 to obtain a unitary array of brightness values that is presented on lenticular display 14.

In another possible arrangement, pixel mapping circuitry 108 may superimpose the mapped class B content to cache 112. In this scenario the cache (with mapped class A and class B content) may be combined with mapped class C content in frame buffer 114.

It is noted that the ray tracing and pixel mapping operations may only be applied to pixels that fall within a bounding box associated with the class B content. There is therefore a processing power savings associated with only processing the pixels within the bounding box while processing the class B content. There is also a processing power savings associated with only performing ray tracing for the class B content when the three-dimensional topology of the class B content changes.

Next, consider class C content. Class C content may include content that is frequently updated in its two-dimensional appearance and/or three-dimensional topology. The class C content may move to different positions within display 14. The class C content may include dynamic game content, a second hand for a watch face, a minute hand for a watch face, etc.

The rendered class C content may be updated at a third frequency f₃. Frequency f₃ may be greater than f₁ for the class A content. Frequency f₃ may be greater than f₂ for the class B content.

As shown in FIG. 13, the rendered class C content may be provided to pixel mapping circuitry 108 and ray tracing circuitry 104. The pixel mapping circuitry 108 may use a class C calibration map associated with the class C content to map the class C content to sub-pixels on display 14. The class C calibration map may be obtained by ray tracing circuitry 104. As previously discussed, ray tracing circuitry 104 uses deflection measurements 106 to output a display calibration map that includes, for each sub-pixel in display 14, the location of a corresponding point on the two-dimensional image of the given content (e.g., the 2D image of the class C content). In other words, the display calibration map is updated to account for the topology associated with surface 136 for the class C content.

Because the topology associated with surface 136 for the class C content is, generally, continuously updated at frequency f₃, the ray tracing operations may be performed at frequency f₃. Pixel mapping circuitry 108 may output the mapped class C content to frame buffer 114. During each display frame, the class C content (as well as the class B content) may be superimposed on the class A content from cache 112 to obtain a unitary array of pixel values that is presented on lenticular display 14.

It is noted that the ray tracing and pixel mapping operations may only be applied to pixels that fall within a bounding box associated with the class C content. There is therefore a processing power savings associated with only processing the pixels within the bounding box while processing the class C content.

Cache 112 may include an array of pixel values for all of the sub-pixels in display 14. This array of pixel values may be provided to frame buffer 114 as a baseline for each display frame. For each display frame, pixel values associated with the bounding box of the class B content are used to replace the pixel values from the cache where applicable and pixel values associated with the bounding box of the class C content are used to replace the pixel values from the cache where applicable. The resulting array of pixel values represents the class B content and the class C content overlaid on the class A content.

As shown in FIG. 13, the resulting array of pixels values is provided from frame buffer 114 to display driver circuitry 30. The pixel data provided to display driver circuitry 30 includes a brightness level (e.g., voltage) for each pixel in pixel array 74. The display driver circuitry 30 uses the received pixel values to display images on pixel array 74 (e.g., using data lines D).

Content rendering circuitry 102, ray tracing circuitry 104, pixel mapping circuitry 108, cache 112, and frame buffer 114 may be considered part of display 14 and/or control circuitry 16.

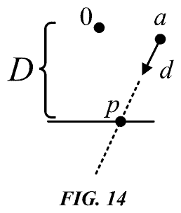

Another way to render content for multiple layers is to use ray tracing for all of the multiple layers of content. FIG. 14 shows a way to use ray tracing in a computationally efficient manner for multiple layers of content. FIG. 14 shows an example for solving the intersection of a ray with a plane. As shown in FIG. 14, the plane (that includes point p) of a layer of content is separated from the front of the display (0) by a distance D. In FIG. 14, a is the point in three-dimensional space from which the ray (used for the ray tracing) originates and d is the direction of the ray used for the ray tracing. Using this arrangement, control circuitry 16 may first solve for when the ray will hit the desired depth D using the equation t= (D−a_{z})/d_{z}. Next, the final point on the plane in three dimensions is found by shifting the origin by the ray direction d scaled by this parameter t:\hat{p}=â+t\hat{d}. Because the order in which the ray strikes the planes is known, the planes may be sorted by depth value and the ray may be traced through the multiple planes.

To optimize the ray tracing computation, the division by dz (which is not depth dependent) may be precomputed: inv_{z}=1/d_{z}. After inv; is computed once, the subsequent ray tracing may be performed at multiple depths using the equations: t=inv_{z}*(D−a_{z}) and \hat{p}=â+t\hat{d}. This technique may be performed for each pixel (or sub-pixel) that is included in the calibration map. In other words, no further division needs to be performed to determine the intersection point at multiple depths and the computational burden of the ray tracing operations may be mitigated.

The foregoing is merely illustrative and various modifications can be made to the described embodiments. The foregoing embodiments may be implemented individually or in any combination.

1. A method of operating a stereoscopic display with an array of display pixels, comprising:
rendering first content for a first layer and second content for a second layer;
mapping the first content to the array of display pixels using a stored calibration map; and
for each frame in the second content:
ray tracing to determine a respective calibration map for that frame; and
mapping the second content to the array of display pixels using the respective calibration map for that frame.

2. The method defined in claim 1, further comprising:
rendering third content for a third layer that is between the first and second layers; and
mapping the third content to the array of display pixels using at least a rotational transform.

3. The method defined in claim 2, wherein the first content comprises background content.

4. The method defined in claim 2, wherein the first content comprises static content.

5. The method defined in claim 4, wherein the second content comprises dynamic content.

6. The method defined in claim 5, wherein the third content comprises rotational content.

7. The method defined in claim 1, further comprising:
outputting the mapped first content to a cache.

8. The method defined in claim 7, further comprising:
for each frame in the second content, providing the mapped first content from the cache to a frame buffer.

9. The method defined in claim 8, further comprising:
for each frame in the second content, replacing pixel values in the mapped first content with pixel values from the mapped second content.

10. The method defined in claim 1, wherein mapping the first content to the array of display pixels using the stored calibration map comprises mapping the first content to the array of display pixels using the stored calibration map after rendering the first content for the first layer and wherein ray tracing is not performed to obtain the stored calibration map after rendering the first content for the first layer.

11. The method defined in claim 1, wherein ray tracing to determine the respective calibration map for that frame comprises ray tracing using stored deflection measurements associated with the array of display pixels.

12. The method defined in claim 1, wherein ray tracing to determine the respective calibration map for that frame comprises ray tracing for only a subset of the array of display pixels.

13. The method defined in claim 12, wherein the stereoscopic display has a first footprint with a first size, wherein the second content has a second footprint with a second size, and wherein the subset of the array of display pixels is associated with a bounding box having a third footprint with a third size that is between the first and second sizes.

14. The method defined in claim 1, wherein mapping the first content to the array of display pixels using the stored calibration map comprises mapping the first content to the array of display pixels using the stored calibration map at a first frequency and wherein ray tracing to determine the respective calibration map for that frame comprises ray tracing to determine the respective calibration map for that frame at a second frequency that is greater than the first frequency.

15. An electronic device, comprising:
an array of display pixels that presents images in sequential frames;
lenticular lenses formed over the array of display pixels;
a cache that is configured to store mapped background content for the array of display pixels;
a frame buffer that is configured to, for each one of the sequential frames, receive the mapped background content from the cache and dynamic content that is mapped based on ray tracing; and
display driver circuitry configured to receive an array of brightness values for the array of display pixels from the frame buffer and drive the array of display pixels using the array of brightness values.

16. The electronic device defined in claim 15, further comprising:
pixel mapping circuitry configured to output the dynamic content to the frame buffer.

17. The electronic device defined in claim 16, wherein the pixel mapping circuitry is configured to output the mapped background content to the cache.

18. The electronic device defined in claim 16, wherein the pixel mapping circuitry is configured to receive a calibration map associated with rendered dynamic content and output the dynamic content based on the calibration map and the rendered dynamic content.

19. An electronic device, comprising:
an array of display pixels;
lenticular lenses formed over the array of display pixels; and
ray tracing circuitry that is configured to:
receive first rendered content at a first frequency;
output a first calibration map associated with the first rendered content at the first frequency;
receive second rendered content at a second frequency that is greater than the first frequency; and
output a second calibration map associated with the second rendered content at the second frequency.

20. The electronic device defined in claim 19, further comprising:
pixel mapping circuitry configured to map the first rendered content to the array of display pixels using the first calibration map and map the second rendered content to the array of display pixels using the second calibration map.

21. A method of operating a stereoscopic display with an array of display pixels, comprising:
rendering first content for a first layer at a first apparent depth and second content for a second layer at a second apparent depth; and
performing ray tracing to calculate intersection points of rays associated with the array of display pixels with the first and second layers, wherein performing the ray tracing comprises, for each pixel in the array of display pixels:
determining an inverse of a direction of a ray associated with that pixel; and
using the inverse of the direction of the ray to determine a first intersection point with the first layer and a second intersection point with the second layer.
